(19) United States
(12) Patent Application Publication
(10) Pub. No.: US 2017/0074667 A1
(43) Pub. Date: Mar. 16, 2017

(54) SEASONAL NAVIGATION SYSTEM FOR AUTOMATED VEHICLES

(71) Applicants: Michael H. Laur, Mission Viejo, CA (US); John P. Absmeier, Capitola, CA (US)

(72) Inventors: Michael H. Laur, Mission Viejo, CA (US); John P. Absmeier, Capitola, CA (US)

(21) Appl. No.: 14/852,881

(22) Filed: Sep. 14, 2015

(51) Int. Cl. G01C 21/34; G05D 1/00

(52) U.S. Cl. CPC G01C 21/34; G05D 1/0088

(57) ABSTRACT

A seasonal navigation system for an automated vehicle includes a memory and a controller. The memory is installed in a vehicle. The memory is programmed with a digital-map that defines a travel-lane of a roadway. The travel-lane is closed during a predetermined-event. The controller is installed in the vehicle. The controller is configured to operate the vehicle in accordance with the digital-map. The controller avoids the travel-lane during the predetermined-event.

### TECHNICAL FIELD OF INVENTION

This disclosure generally relates to a seasonal navigation system for an automated vehicle, and more particularly relates to operating an automated vehicle in accordance with a digital-map that is stored by the automated vehicle and indicates when a travel-lane of a roadway is closed during a predetermined-event.

### BACKGROUND OF INVENTION

It is known to operate an automated vehicle according to a digital-map stored in the automated vehicle. However, available digital-maps do not include indications of seasonal travel-lane closures or seasonal roadway closures.

### SUMMARY OF THE INVENTION

In accordance with one embodiment, a seasonal navigation system for an automated vehicle is provided. The system includes a memory and a controller. The memory is installed in a vehicle. The memory is programmed with a digital-map that defines a travel-lane of a roadway. The travel-lane is closed during a predetermined-event. The controller is installed in the vehicle. The controller is configured to operate the vehicle in accordance with the digital-map. The controller avoids the travel-lane during the predetermined-event.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a seasonal navigation system for an automated vehicle in accordance with one embodiment;

FIG. 2 is traffic-scenario encountered by the system of FIG. 1 in accordance with one embodiment; and

FIG. 3 is traffic-scenario encountered by the system of FIG. 1 in accordance with one embodiment.

### DETAILED DESCRIPTION

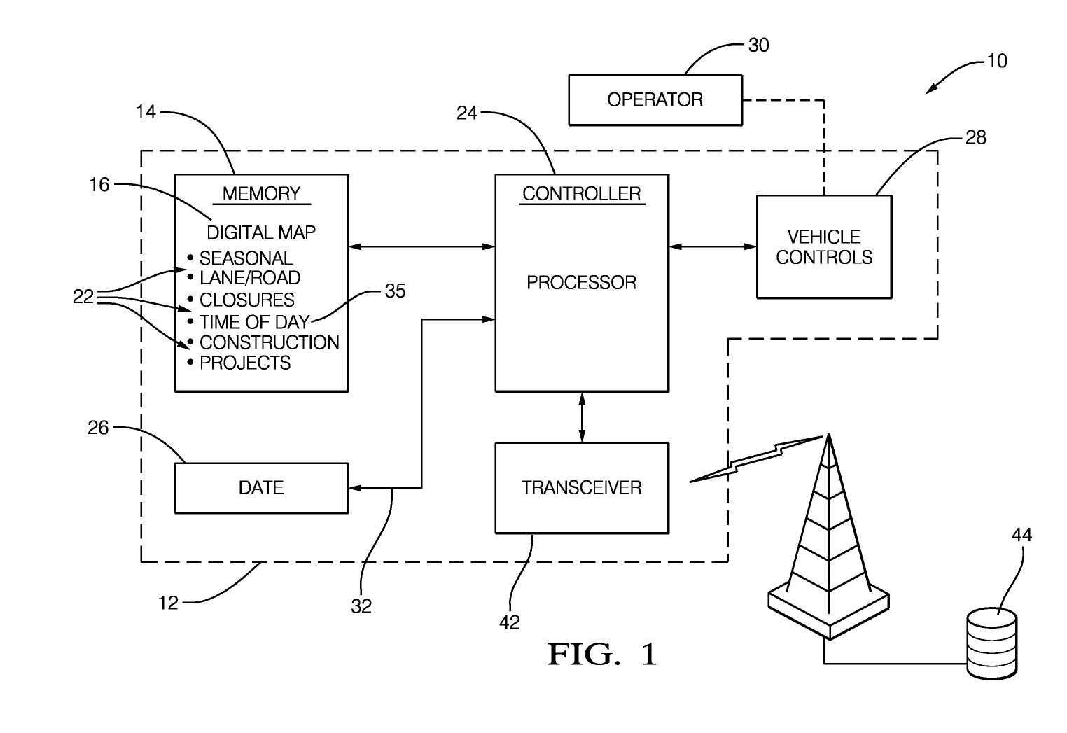

FIG. 1 illustrates a non-limiting example of a seasonal navigation system, hereafter referred to as the system 10, for an automated vehicle, hereafter referred to as the vehicle 12. While the non-limiting examples given herein are generally directed to a fully automated vehicle, i.e. an autonomous vehicle, those in the art will recognize that the teachings presented herein will be useful on vehicles that are partially automated, i.e. vehicles that are generally driven by an operator 30, and the operator 30 is assisted to drive the vehicle by the system 10. The system 10 described herein overcomes the problems of seasonal closures of roadways or selected travel-lanes of a roadway described above by considering during what calendar dates that a roadway or travel-lane of a roadway are expected to be closed.

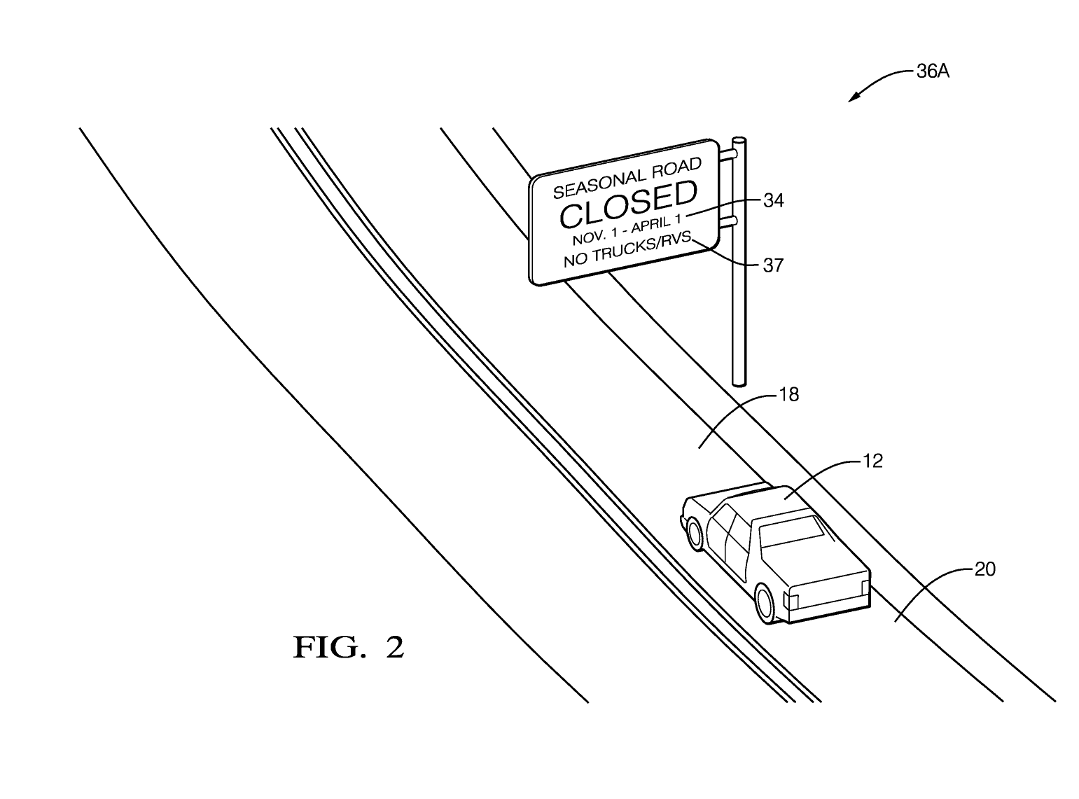

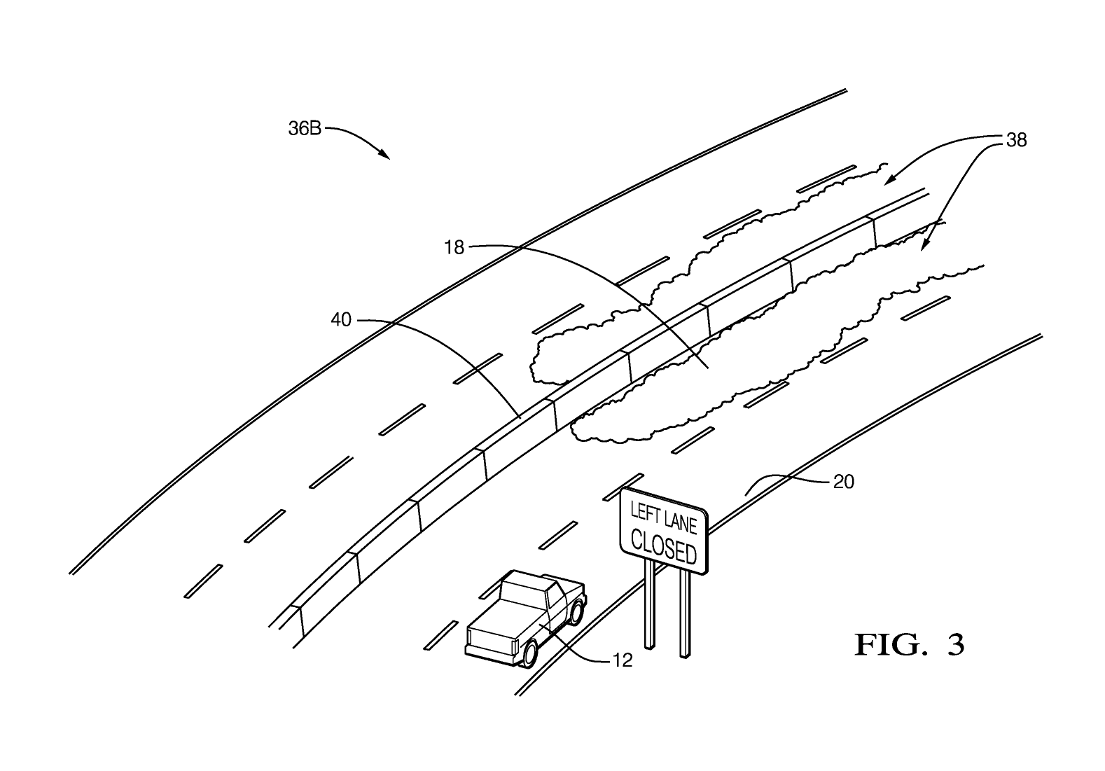

In order for the system 10 to determine when (e.g. what dates) a roadway or travel-lane of a roadway are expected to be closed, the system 10 includes a memory 14 installed in the vehicle 12, which is programmed with a digital-map 16 that defines a travel-lane 18 (FIGS. 2-3) of a roadway 20, wherein the travel-lane 18 is closed during a predetermined-event 22. As used herein, the predetermined-event 22 is used to indicate instances when the roadway 20 and/or the travel-lane 18 are closed as part of a pre-planned or predetermined-event such a construction-event or a winter-time closing of a mountain pass. As such, the term ‘predetermined-event’ does not include instances when the roadway 20 and/or the travel-lane 18 are closed due to some unexpected event such as a traffic accident or mudslide. By way of example and not limitation, a ‘predetermined-event’ is one that is known at least a month in advance.

The system 10 also includes a controller 24 installed in the vehicle 12 and in communication with or connected to the memory 14. The controller 24 is generally configured to operate the vehicle 12 in accordance with the digital-map 16. In particular, the controller operates the vehicle 12 to avoid the travel-lane 18 which is closed during the predetermined-event 22. Accordingly, the system includes a date-indicator 26 operable to indicate a calendar-date 32 and/or time-of-day to the controller 24. The date-indicator 26 may be, for example, a typical digital clock IC or may be a radio receiver configured to detect radio broadcast signals that include date and time information, as will be recognized by those in the art.

In order for the controller 24 to be able operate the vehicle, the system 10 includes vehicle-controls 28 operable to control one or more of acceleration, braking, and steering of the vehicle 12. Multiple configurations of the vehicle-controls 28 are contemplated. For example, in one configuration the steering-wheel may rotate as the controller 24 varies the steering direction of the vehicle 12. In this case, the system 10 may be configured so the operator 30 could physically overcome the intent of the controller 24 via the manual-controls. Alternatively, the vehicle 12 may not have a steering-wheel or any means for the operator 30 to influence the steering direction of the vehicle 12. That is, the vehicle 12 may be configured to operate in a fully-automated or autonomous mode where the operator 30 of the vehicle 12 cannot influence the manual-controls that control acceleration, braking, or steering of the vehicle 12, so the controller 24 may have total or absolute control of the manual-controls. As another alternative, the vehicle-controls 28 may include a control-override be able to decouple the steering-wheel from the steering mechanism that controls the steering direction of the vehicle 12 and thereby override any attempt by the operator 30 to influence or otherwise steer the vehicle 12.

FIGS. 2-3 illustrate non-limiting examples of traffic scenarios (36A, 36B) when the roadway 20 and/or the travel-lane 18 are closed as part of a predetermined-event 22 (FIG. 1). FIG. 2 illustrates a traffic scenario 36A when the predetermined-event 22 includes seasonal-dates 34 of a year. In this example the entirety of the roadway 30 is closed during the predetermined-event, e.g. winter-time when seasonally-reoccurring weather conditions that make the roadway 20 unsafe for travel or impassable are expected. This scenario is common in mountainous areas where high-elevation mountain passes are closed during the winter-time and alternate longer routes at lower elevations should be selected by the system 10. Alternatively, or in addition to the seasonal-dates 34, the predetermined-event 22 may include a time-of-day 35 (FIG. 1) that specifies certain times of the day (e.g. 10:00 pm to 6:00 am) when the roadway 20 and/or the travel-lane 18 are closed as part of a predetermined-event 22. By way of example, the roadway 20 may provide access to a public park, and the park may be closed during the nighttime. Alternatively, or in addition to any of the other factors described above that may restrict use of the roadway 20, the travel-lane 18 may be closed to a type-of-vehicle 37 (FIG. 2). For example, the roadway may be too narrow or twisty to accommodate relatively long vehicles such as trucks (i.e. tractor/trailer combinations) or RV's (e.g. motor-homes or towed-trailers).

FIG. 3 illustrates a traffic scenario 36B when predetermined-event 22 includes road-construction 38. The road-construction 38 is typically scheduled well in advance of the start of the road-construction 38, so the schedule can be included in the digital-map 16. In this example, the roadway 20 includes multiple travel lanes, and not all of the travel-lanes are closed during the predetermined-event 22. By way of example and not limitation the travel-lane 18 that is closed may be dirt surface unsuitable for travel by the vehicle 12, or may have accumulated snow that is difficult to remove from the roadway 20 because of a barrier 40. The traffic scenario 36B with unremoved snow is one that may be encountered in areas where there is a lot of summer-time vacation traffic, but because of the reduced traffic quantities during the winter, it is unnecessary to spend the money to keep the travel-lane 18 clear of snow.

It is envisioned that the digital-map 16 would be updated at least annually (once per year), but no more often than quarterly (four times per year). Such infrequent updates allow for updates of the digital-map 16 to be carefully considered and not overly burdensome on the system 10 to keep the digital-map 16 updated. It is envisioned that updates would occur when the vehicle 12 was parked at a home of the operator 30 so, for example, a secured WI-FI® connection could be used for the update rather than a more expensive option for data transfers such as a cellular network. Accordingly, the system 10 may include a transceiver 42 operable to wirelessly communicate with an internet server 44.

Accordingly, a seasonal navigation system (the system 10) for an automated vehicle (the vehicle 12), and a controller 24 for the system 10 is provided. The system 10 is configured so the digital-map 16 is stored on the vehicle 12 rather than stored ‘in the cloud’ so the system 10 does not require constant internet connection to navigate the vehicle 12.

While this invention has been described in terms of the preferred embodiments thereof, it is not intended to be so limited, but rather only to the extent set forth in the claims that follow.

We claim:

1. A seasonal navigation system for an automated vehicle, said system comprising:
a memory installed in a vehicle and programmed with a digital-map that defines a travel-lane of a roadway, wherein the travel-lane is closed during a predetermined-event; and
a controller installed in the vehicle and configured to operate the vehicle in accordance with the digital-map, wherein the controller avoids the travel-lane during the predetermined-event.

2. The system in accordance with claim 1, wherein the predetermined-event includes seasonal-dates of a year.

3. The system in accordance with claim 1, wherein the predetermined-event includes a time-of-day.

4. The system in accordance with claim 1, wherein the predetermined-event includes road-construction.

5. The system in accordance with claim 1, wherein the roadway includes multiple travel lanes, and not all travel-lanes of the roadway are closed during the predetermined-event.

6. The system in accordance with claim 1, wherein the roadway includes multiple travel lanes, and not all travel-lanes are closed during the predetermined-event.

7. The system in accordance with claim 1, wherein the travel-lane is closed to a type-of-vehicle.

6. The system in accordance with claim 1, wherein the system includes a date-indicator operable to provide a calendar-date to the system.

7. The system in accordance with claim 1, wherein the digital-map is at least one time per year and no more than four times per year.
